(19) United States
(12) Patent Application Publication
(10) Pub. No.: US 2024/0425129 A1
(43) Pub. Date: Dec. 26, 2024

(54) THREADLESS POSITIONING FASTENER, PIN, AND RETAINER, AND RELATED ASSEMBLIES AND METHODS

(71) Applicant: AlphaUSA, Livonia, MI (US)

(72) Inventors: Robert E. Stewart, Farmington Hills, MI (US); Joseph L. Dillon, Louisville, KY (US); Leah Wagoner, Sellersburg, IN (US); Joseph J. Novack, South Lyon, MI (US); Lawrence F. Liotino, Commerce Township, MI (US); Catherine Strumbos, Bloomfield Hills, MI (US); Thomas Strangway, Bloomfield Hills, MI (US); Brian Nau, Bloomfield Hills, MI (US)

(73) Assignees: AlphaUSA, Livonia, MI (US); Ford Motor Company, Dearborn, MI (US)

(21) Appl. No.: 18/213,243

(22) Filed: Jun. 22, 2023

(51) Int. Cl. B62D 65/02; F16B 1/00

(52) U.S. Cl. CPC B62D 65/024; F16B 1/00; F16B 2200/99

(57) ABSTRACT

In one embodiment, a threadless positioning pin includes a head end, a pilot end, a positioning shank, a retainer shank, and a keyway. In another embodiment, a threadless positioning retainer includes a first end, a second end, an exterior, and an interior with a key extending from an inner surface proximate the first end. In another embodiment, a threadless positioning fastener includes a threadless positioning pin and a threadless positioning retainer, including an interior with a key configured to ride in a keyway of the threadless positioning pin. In another embodiment, a method of joining assembly elements includes providing a primary element, advancing a threadless positioning pin through a positioning hole so that a key rides along a keyway, and rotating the threadless positioning pin so that the key engages the keyway to trap the primary element between the threadless positioning pin and a threadless positioning retainer.

### TECHNICAL FIELD

This disclosure relates generally to mechanical engineering devices for joining elements together and, more particularly, to positioning pin devices that facilitate precision positioning of elements relative to one another prior to securing the elements together.

### BACKGROUND

In building construction, civil engineering, automotive, and many other industries, it is important to precisely position a secondary element relative to a primary element before securing the secondary element to the primary element. In one example, a girder must be precisely positioned relative to a building framework before the girder is riveted to the framework. In a further example, a beam must be precisely positioned relative to a bridge superstructure before the beam is secured to the superstructure. In another example, a truck body must be precisely positioned relative to an underlying truck frame before the body is fastened to the frame. For instance, primary, secondary, and tertiary positioning pins are inserted through corresponding precision positioning holes in the frame and then the body is lowered onto the frame so that the primary positioning pin enters a corresponding round primary locating hole in the body and then the secondary and tertiary positioning pins enter corresponding oblong locating slots in the frame. The primary locating pin is made of metal, is longer than secondary and tertiary positioning pins which are sacrificial and polymeric, and is a dedicated part of a locating and positioning jig that clamps to the frame before the body is lowered onto the frame. For many people, the locating and positioning jig is too cumbersome to use in tight spaces on an assembly line.

### SUMMARY

In one embodiment of the present disclosure, a threadless positioning pin extends along a longitudinal axis and includes a head end including a head with a head end surface and a flange spaced away from the head end surface. The threadless positioning pin also includes a pilot end including a point with a point end surface and a tapered surface extending away from the point end surface toward the head end. The threadless positioning pin further includes a positioning shank extending away from the tapered surface toward the head end. The threadless positioning pin also includes a retainer shank greater in diameter than the positioning shank and extending away from the positioning shank toward the head. The threadless positioning pin further includes a keyway in the positioning and retainer shanks. The keyway includes a longitudinal portion extending along part of the retainer shank, a circumferential portion extending around a part of the retainer shank between the longitudinal portion and the flange of the head end, and a transition portion extending between and connecting the longitudinal and circumferential portions.

In another embodiment of the present disclosure, a threadless positioning retainer extends along a longitudinal axis and includes a first end with a first end surface, a second end spaced longitudinally from the first end and having a second end surface, an exterior, and an interior including a threadless cylindrical inner surface and a key extending radially inwardly from the inner surface proximate the first end.

In another embodiment of the present disclosure, a threadless positioning fastener extends along a longitudinal axis and includes a threadless positioning pin. The threadless positioning pin includes a head end including a head with a head end surface and a flange spaced away from the head end surface. The threadless positioning pin also includes a pilot end including a point with a point end surface and a tapered surface extending away from the point end surface toward the head end. The threadless positioning pin further includes a positioning shank extending away from the tapered surface toward the head end. The threadless positioning pin also includes a retainer shank greater in diameter than the positioning shank and extending away from the positioning shank toward the head. The threadless positioning pin further includes a keyway in the positioning and retainer shanks. The keyway includes a longitudinal portion extending along the positioning shank and along part of the retainer shank, a circumferential portion extending around part of the retainer shank between the longitudinal portion and the flange of the head end, and a transition portion extending between and connecting the longitudinal and circumferential portions. The threadless positioning fastener also includes a threadless positioning retainer. The threadless positioning retainer includes a first end with a first end surface, a second end spaced longitudinally from the first end and having a second end surface, an exterior, and an interior including a threadless cylindrical inner surface and a key extending radially inwardly from the inner surface proximate the first end and configured to ride in the keyway of the threadless positioning pin.

In another embodiment of the present disclosure, a method of joining assembly elements includes providing a primary element including a plate portion with a positioning hole, and a threadless positioning retainer corresponding to the positioning hole and having a threadless cylindrical inner surface and a key extending radially inwardly from the inner surface. The method also includes advancing a threadless positioning pin along a first longitudinal direction into and through the positioning hole of the plate portion and the threadless positioning retainer of the primary element so that the key rides along a longitudinal portion of a keyway in the threadless positioning pin. The method further includes rotating the threadless positioning pin in a first circumferential direction relative to the primary element so that key rides along a transition portion of the keyway and engages a circumferential portion of the keyway to trap the plate portion of the primary element between a head of the threadless positioning pin and a first end of the threadless positioning retainer.

### BRIEF DESCRIPTION OF THE DRAWINGS

FIG. 1 is a schematic, perspective view of one embodiment of a threadless positioning fastener and associated assembly elements before being fully joined;

FIG. 2 is a schematic, perspective view of the threadless positioning fastener and joined assembly elements of FIG. 1;

FIG. 3 is a schematic, perspective view of the joined assembly elements of FIGS. 1 and 2, showing removal of the threadless positioning pin;

FIG. 4 is a schematic, perspective view of the joined assembly elements of FIGS. 1-3, showing removal of the threadless positioning retainer;

FIG. 5 is side view of the threadless positioning retainer of FIGS. 1-4;

FIG. 6 is a bottom view of the threadless positioning retainer of FIGS. 1-5;

FIG. 7 is a perspective view of the threadless positioning retainer of FIGS. 1-6;

FIG. 8 is a partial, bottom view of the threadless positioning retainer of FIGS. 1-7;

FIG. 9 is a bottom view of the threadless positioning retainer of FIGS. 1-8 installed in the assembly;

FIG. 10 is a perspective view of one embodiment of a threadless positioning pin;

FIG. 11 shows the threadless positioning pin of FIGS. 1-3; and

FIG. 12 is a fragmentary view of the threadless positioning fastener of FIGS. 1-3 and 11 showing the joined threadless positioning pin and threadless positioning retainer; and

FIG. 13 is an enlarged fragmentary view of the threadless positioning pin and retainer of FIG. 12, but illustrating a key of the retainer located at a terminus of a keyway of the pin.

### DETAILED DESCRIPTION

The threadless positioning fastener disclosed herein can be used to more efficiently locate and precisely position assembly elements. Positioning fasteners are oftentimes used in larger scale assemblies (e.g., joining a truck body to a frame, a rail car or shipping container to a platform, etc.) to enable proper placement of the assembly elements when a secondary positioning fastener or more permanent joining fasteners are used to further finalize the joined assembly. These positioning fasteners typically had a threaded joining arrangement which required an operator or the like to screw the threaded pin into the assembly for proper positioning and placement. The present threadless positioning fastener, on the other hand, includes a particularly configured key and retainer arrangement that avoid the need for excess screwing of the positioning fastener assembly, while maintaining a requisite secure junction between the pin and the retainer. This structure can streamline manufacture and decrease cycle times, to cite a few advantages.

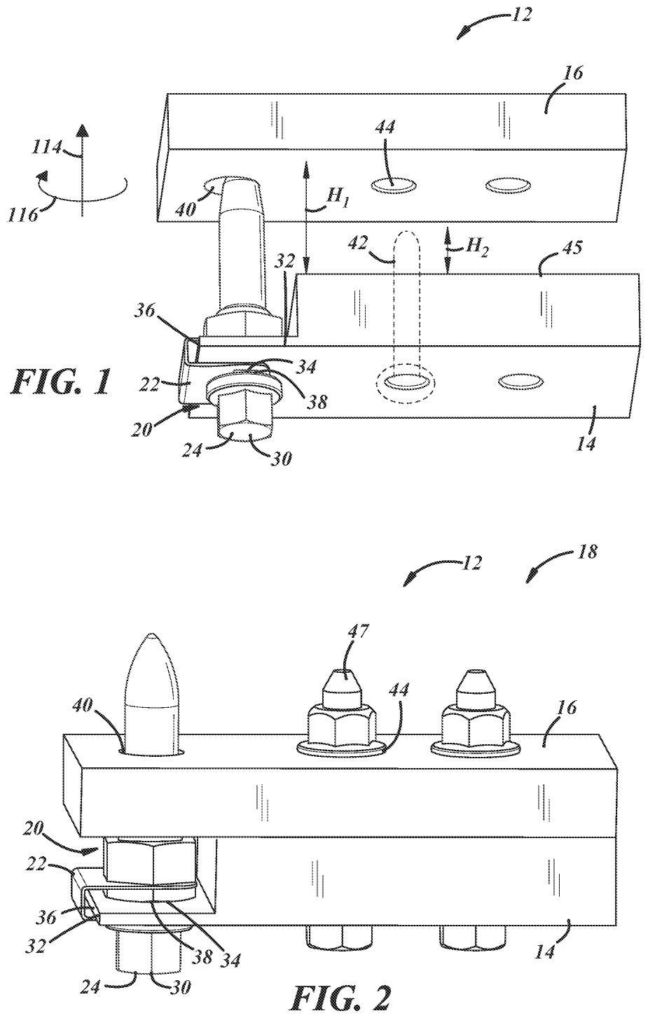

FIGS. 1-4 schematically illustrate an assembly 12 comprising a primary element 14 and a secondary element 16. A joined assembly 18 includes the primary element 14 and secondary element 16 in proper position and rigid attachment, in this schematic representation. A threadless positioning fastener 20 having a threadless positioning retainer 22 and a threadless positioning pin 24 is used to help position and locate the secondary element 16 relative to the primary element 14 for subsequent formation of the joined assembly 18.

In an example embodiment, the primary element 14 is a truck frame and the secondary element 16 is a truck body, although these components are schematically illustrated in FIGS. 1-4. These larger scale elements 14, 16 can be difficult to assemble, given their respective weights and sizes. Moreover, given these larger scale weights and sizes, a secure attachment of the positioning pin 24 to the retainer 22 and to the primary element 14 is desirable since the weight of the secondary element 16 may impact the assembly process and position of the fastener 20. This can then undesirably impact the position of the primary element 14 with respect to the secondary element 16. While threaded attachment of the pin and retainer can be used to accomplish this, such a solution results in longer manufacturing times as the pin must be screwed in several times with respect to the retainer and/or the primary element. Thus, the threadless positioning fastener 20 having a threadless retainer 22 and a threadless positioning pin 24, where the threadless pin 24 only requires a ¼ or ¾ turn, in some embodiments, can enhance the manufacturing process while maintaining the requisite security and positioning ability.

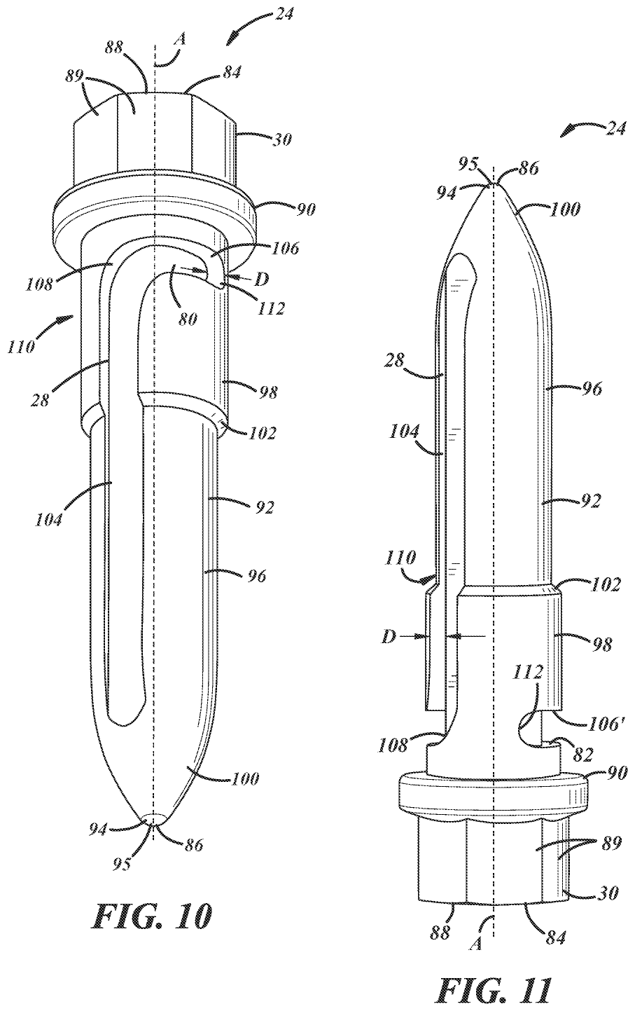

As will be detailed more substantially herein, the threadless positioning fastener 20 with the threadless retainer 22 and the threadless positioning pin 24 are structured so as to efficiently allow for easier installation, as compared with threaded positioning pins and retainers that are typically needed for secure attachment. The threadless retainer 22 and the threadless positioning pin 24 are structured with a key 26 (FIG. 6) and keyway 28 (FIG. 10), respectively, to facilitate a secure attachment while minimizing the amount of turning that needs to be accomplished. In an example embodiment, the threadless pin 24 requires only a ¼ or ¾ turn with respect to the retainer 22 to facilitate this locking attachment. Further, “threadless” is used as a way herein to distinguish locking arrangements that require more than one turn via helical threads between a pin and retainer. Thus, for example, it is possible to have a threadless fastener 20 that includes one or more threads for other components of the fastener 20 (e.g., the head 30 of the positioning pin 24 may be engaged with threads) so long as the pin 24 and the retainer 22 themselves are not engaged via cooperating threads.

FIG. 1 schematically illustrates the threadless positioning fastener 20 installed in the primary element 14, while the secondary element 16 is positioned with respect to the primary element 14. The primary element 14 includes a plate portion 32 having a positioning hole 34. In the illustrated embodiment, the threadless positioning retainer 22 is installed on the plate portion 32 so as to wrap around an edge 36 and provide a through hole 38 for installation of the threadless positioning pin 24. After installation of the threadless positioning pin 24, the secondary element 16 is guided over the primary element 14 and oriented such that the pin extends up into a primary locating hole 40 in the secondary element 16. As schematically illustrated in FIG. 1, the pin 24 extends up to and through the primary locating hole 40 before potentially reaching one or more other secondary positioning pins 42, which may be included in the primary element 14 as represented in dotted lines. The one or more secondary positioning pins 42 can then mate with one or more secondary locating holes 44. The height H1 of the pin 24 above a mating surface 45 of the primary element 14 is greater than a height H2 of the secondary positioning pin 42 above the mating surface 45. This arrangement allows for the secondary element 16 to be located to the threadless positioning pin 24 before the secondary positioning pin 42 is located to its corresponding locating hole 44. Thus, the pin 24, which can be made of metal, can take the brunt of the positioning load so that the secondary positioning pin 42 can be smaller and/or composed of a polymeric material such as nylon. Additionally, the secondary positioning pin 42 can be sacrificial and remain with the joined assembly. In other embodiments, the secondary positioning pin 42 is removed. In yet other embodiments, as shown in FIGS. 2-4, the locating hole 44 is used to accommodate a securing fastener 47. It is certainly possible to include a plurality of secondary positioning pins 42 as well as a plurality of securing fasteners 47 in the same joined assembly 18, with the number and arrangement of which being largely dictated by the size and configuration of the primary and secondary elements 14, 16. The installation methodology is explained further below after the details regarding the threadless positioning retainer 22 and the threadless positioning pin 24.

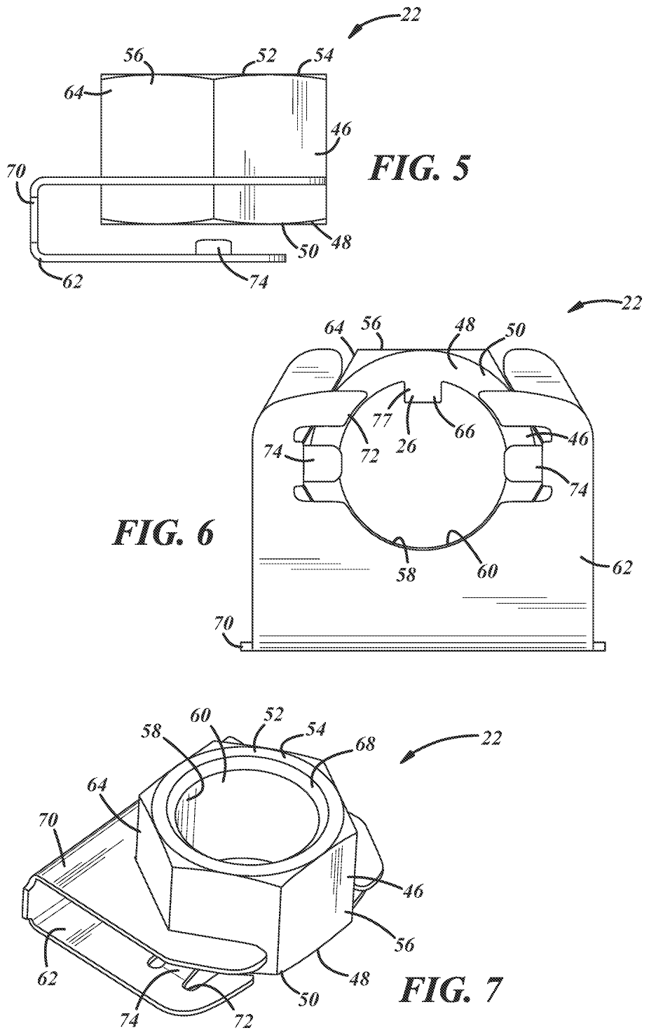

FIGS. 5-9 show various views of one embodiment of the threadless positioning retainer 22. The threadless positioning retainer 22 includes a main body 46 having a first end 48 and a first end surface 50 and an opposite second end 52 and second end surface 54. The first end 48 and first end surface 50 are configured to directly contact and face the plate portion 32 of the primary element 14. The main body 46 further includes an exterior 56 and an interior 58, with the interior having a threadless cylindrical inner surface 60. A clip 62 is integrated into the main body 46 to help anchor the retainer 22 to the primary element 14.

In the illustrated embodiments, the main body 46 of the threadless positioning retainer 22 has a hex configuration 64 on its exterior 56, and a threadless cylindrical inner surface 60 on its interior 58 with the key 26 extending from the inner surface. It is possible to have alternate configurations for the main body 46, as well as the clip 62, depending on factors such as specifications of the assembly 12, manufacturing related tooling and equipment, etc. In the illustrated embodiment, the main body 46 is configured to have the key 26 located at the second end 52 of the threadless cylindrical inner surface 60. This creates a key end surface 66 that is co-planar with the second end surface 54. This arrangement may be easier to manufacture, for example; however, it is possible to locate the key 26 in a different location with respect to the threadless cylindrical inner surface 60. The illustrated embodiment also includes a chamfer 68 which serves as a transition portion to the threadless cylindrical inner surface 60. In this particular implementation, chamfers 68 are located adjacent the first end surface 50 and the second end surface 54, respectively, to help diametrically transition to the threadless cylindrical inner surface 60.

The clip 62 is attached to or otherwise integrated with the main body 46 of the threadless positioning retainer 22 so as to facilitate attachment of the fastener 20 to the primary element 14. The clip 62 in the embodiment illustrated in FIGS. 5-7 and 9 has a projecting U-shaped member 70 that is configured to fit over the edge 36 of the plate portion 32 in the primary element 14. Other attachment mechanisms are certainly possible, and in some embodiments, the threadless positioning retainer 22 may not have a dedicated clip 62 with a projecting U-shaped member 70. To cite one example, the threadless positioning retainer 22 may be an integrated part of the primary element 14. In such an embodiment, the threadless positioning pin 24 could engage into a pierced hole having a tooth that is stamped into the primary element 14 (e.g., a panel or frame). In embodiments where the primary element 14 is mild steel without heat-treatment, it may be better to use the retainer 22, as a stamped locking tooth could relax and/or be bent out of location when the pin 24 is locked into place. With a retainer 22, the Rockwell hardness can be more precisely controlled to ensure strong compression of the primary element 14 in the joint with no or minimal relaxation of the clamp force over time. To cite one specific example, if the positioning pin 24 is secured in a truck frame primary element 14, but the assembly line shuts down for a certain period of time, using a hardened and tempered retainer 22 engaged with a hardened and tempered pin 24 results in a robust clamp load with minimal relaxation regardless of the time delay before joint assembly. Additionally, use of a separate retainer 22 can help accommodate potential thickness variations in the panel or primary element 14.

In the illustrated embodiments of FIGS. 5-7 and 9, the clip 62 of the threadless positioning retainer 22 has an aperture 72, with a diameter of the aperture generally coinciding with a diameter of the threadless inner cylindrical surface 60, to allow for an unobstructed through hole 38 for insertion of the threadless positioning pin 24. The aperture 72 includes opposing flex tabs 74 which help facilitate engagement with the positioning hole 34. The flex tabs 74 may mechanically lock into the positioning hole 34, and in some embodiments, the positioning hole 34 may have a plurality of lobes 76 (see e.g., FIGS. 4 and 9) to help facilitate placement and attachment of the flex tabs 74 and ultimately, more precisely place the threadless positioning retainer 22 with respect to the primary element 14. Other configurations for the clip 62 and/or the positioning hole 34 are certainly possible. The key 26 may be positioned opposite from the U-shaped member 70, as shown in FIGS. 5 and 6.

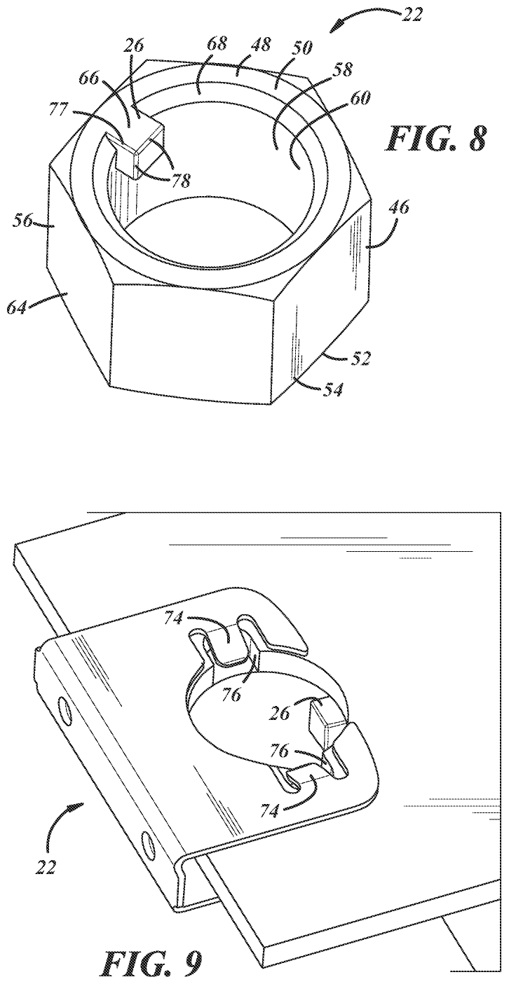

With particular reference to FIG. 8, which illustrates the threadless positioning retainer 22 without the clip 62, the key 26 is shown, which is configured to slidingly engage into the keyway 28 of the threadless positioning pin 24. The key 26 in this embodiment has a cube-shaped profile 77 with a plurality of a tapered edges 78. The cube-shaped profile 77 projects from the threadless inner cylindrical surface 22 and the chamfer 68, positioned to create a co-planar arrangement with the first end surface 50. The chamfer 68 along with the tapered edges 78 on the cube-shaped profile 77 can help ease transitional movement between the threadless positioning retainer 22 and the threadless positioning pin 24. In other embodiments, it is possible to vary the shape of the key 26, and the configuration and arrangement of the key will largely depend on the configuration of the keyway 28 of the threadless positioning pin 24. Additionally, it may be possible to have more than one key 26 and/or keyway 28, but having only a single key 26 can be easier to manufacture and install for positioning of the primary and secondary elements 14, 16.

FIGS. 10 and 11 illustrate two embodiments of the keyway 28 of the threadless positioning pin 24, which receives the key 26 of the threadless positioning retainer 22. The embodiment of the positioning pin 24 shown in FIG. 10 has a ¼ turn 80 keyway 28, and the embodiment shown in FIG. 11 has a ¾ turn 82 keyway. Each of the positioning pins 24 extend along a longitudinal axis A from a head end 84 to a pilot end 86. The head end 84 includes a head end surface 88 on the head 30. The head 30 is a hex head in this embodiment, having a plurality of wrench flats 89. Other configurations for the head 30 are certainly possible, and may vary depending on different conditions as explained with respect to the hex configuration 64 of the positioning retainer 22. A flange 90 is spaced from the head end surface 88 and serves to delineate head 30 from the primary shank portion 92 of the threadless positioning pin 24. In the illustrated embodiment, the flange 90 is the diametrically largest portion of the threadless positioning pin 24 and can help act as a stop or brace when the pin is installed in the retainer 22.

The primary shank portion 92 of the threadless positioning pin 24 extends from a point 94 and point end surface 95 at the pilot end 86 up to the flange 90. The primary shank portion 92 in this embodiment is subdivided into a positioning shank 96 and a retainer shank 98. The positioning shank 96 includes a tapered surface 100 adjacent the point 94. The tapered surface 100 diametrically expands from the point 94 until the portion of the positioning shank 96 where the keyway 28 begins. The tapered surface 100 can help ease installation of the primary locating hole 40 over the positioning pin 24. The remainder of the positioning shank 96 is diametrically consistent until the chamfered edge 102 which delineates the retainer shank 98. The chamfered edge 102 is another diametric expansion from the positioning shank 96 to the retainer shank 98, which like the majority of the positioning shank, is diametrically consistent between the chamfered edge 102 and the flange 90.

The keyway 28 of the threadless positioning pin 24 is located in the positioning shank 96 and the retaining shank 98 to locate, receive, and interlock with the key 26 of the threadless positioning retainer 22. The keyway 28 includes a longitudinal portion 104 extending along part of the retainer shank 98 and a circumferential portion 106, 106′ extending around a part of the retainer shank between the longitudinal portion and the flange 90 of the head end 84. A transition portion 108 extends between and connects the longitudinal portion 104 and the circumferential portion 106, 106′. The keyway 28, and in this embodiment, the longitudinal portion 104, begins on the tapered surface 100 of the pilot end 86. The keyway 28 then extends along the positioning shank 96 and a part 110 of the retainer shank 98 and ends at a terminus 112 of the circumferential portion 106, 106′.

The shape and configuration of keyway 28 may vary from what is particularly illustrated in the figures, but in the illustrated embodiments, having a longitudinal portion 104 that extends parallel to the central or longitudinal axis A and a circumferential portion 106 that extends orthogonally thereto can result in easier and more intuitive installation. In the embodiment shown in FIG. 10, the circumferential portion 106 extends around a quarter of the outer circumference of the retainer shank 98, thus resulting in a ¼ turn 80 configuration. In the embodiment shown in FIG. 11, the circumferential portion 106′ extends around 75% of the outer circumference of the retainer shank 98, thus resulting in a ¾ turn 82 configuration. Both of these arrangements can decrease manufacturing cycle time. In the quarter turn embodiment, the rotation is between 75 and 115 angular degrees, inclusive. In the three-quarter turn embodiment, the rotation is between 255 and 290 angular degrees, inclusive.

The keyway 28 has a variable depth D, which can help better accommodate and lock the key 26. In the illustrated embodiments, the depth D is smallest at the start of the keyway 28 at the tapered surface 100 in the longitudinal portion 104. The depth D then increases to its largest extent at the terminus 112 of the circumferential portion 106, 106′. For ease of manufacturing, the depth D of the keyway 28 may be variable at the tapered surface 100, consistent along positioning shank 96 in the longitudinal portion 104, and then variable again starting at the chamfered edge 102 and extending through the transition portion 108 and the circumferential portion 106, 106′. Having the deepest depth D at the terminus 112 of the circumferential portion 106, 106′ provides increased surface area in the keyway 28 for mechanically locking the key 26.

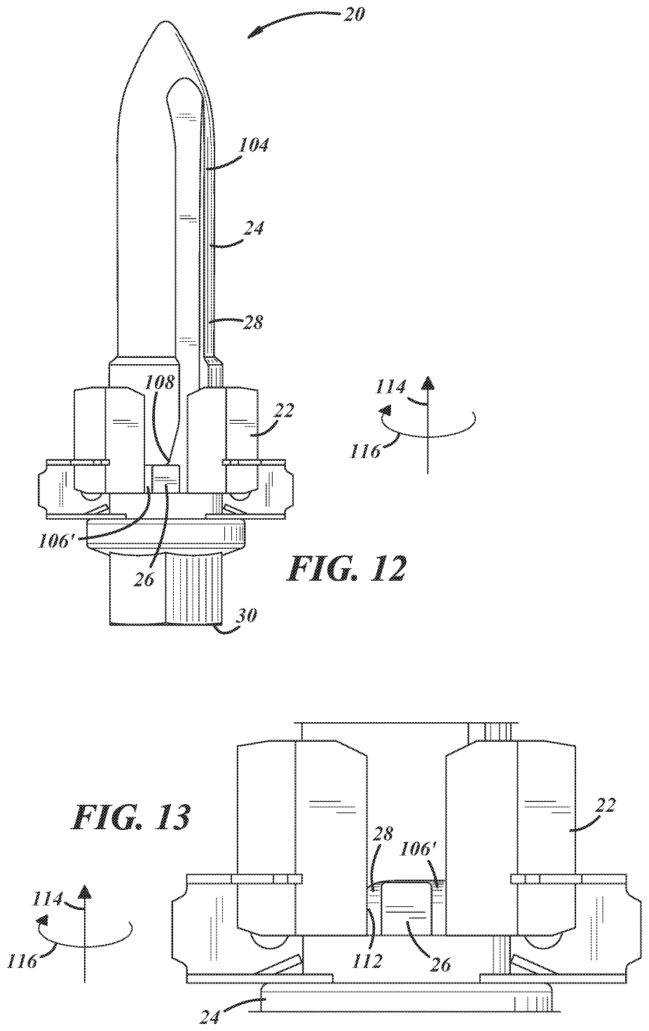

FIGS. 12 and 13 are fragmentary views of the threadless positioning fastener 20 cutaway to show the key 26 of threadless positioning retainer 22 in the keyway 28 of the pin 24. At the transition portion 108, after being inserted up through the retainer 22, the threadless positioning pin 24 is radially turned to lock the key 26 in the keyway 28. This secure attachment between the retainer 22 and the pin 24 allows for proper positioning of the secondary element 16 relative to the primary element 14, as shown in FIG. 1. Accordingly, to facilitate this secure attachment, the threadless positioning pin 24 is advanced along a first longitudinal direction 114 into and through the positioning hole 34 of the plate portion 32. The key 26 of the threadless positioning retainer 22 rides along the longitudinal portion 104 of the positioning pin 24. At the transition portion 108, the threadless positioning pin 24 is rotated in a first circumferential direction 116 relative to the primary element 14 and then engages the circumferential portion 106, 106′ of the keyway 28 to trap the plate portion 32 of the primary element between the head 30 of the pin and the first end 48 of the retainer 22. As shown in FIG. 13, the key 26 is engaged adjacent the terminus 112 of the keyway 28 in the pin 24.

Returning to FIG. 1, after the threadless positioning pin 24 is interlocked with the retainer 22, the secondary element 16 or truck body can be moved relatively toward the primary element 14 or truck frame. When the positioning pin 24 is aligned with the primary locating hole 40 of the secondary element 16, the secondary element can continue to be moved relatively toward the primary element 14 so that the pin 24 enters the primary locating hole. Once the positioning of the primary element 14 and the secondary element 16 is accomplished using the threadless positioning fastener 20, one or more secondary positioning pins 42 may be located in one or more secondary locating holes 44, and one or more securing fasteners 47 may be installed. Only one pin 42/fastener 47 and hole 44 are labeled in the figures, but there can be two as illustrated, or more depending on various factors such as the weight and size of the assembly 12. In some implementations, the positioning of the secondary positioning pins 42 and/or securing fasteners 47 can be varied in both an X and Y direction to improve the securement of the assembly 12 in more than one dimension. In yet other implementations, there may not be any securing fasteners 47, and instead, the primary and secondary elements 14, 16 may be welded or otherwise attached.

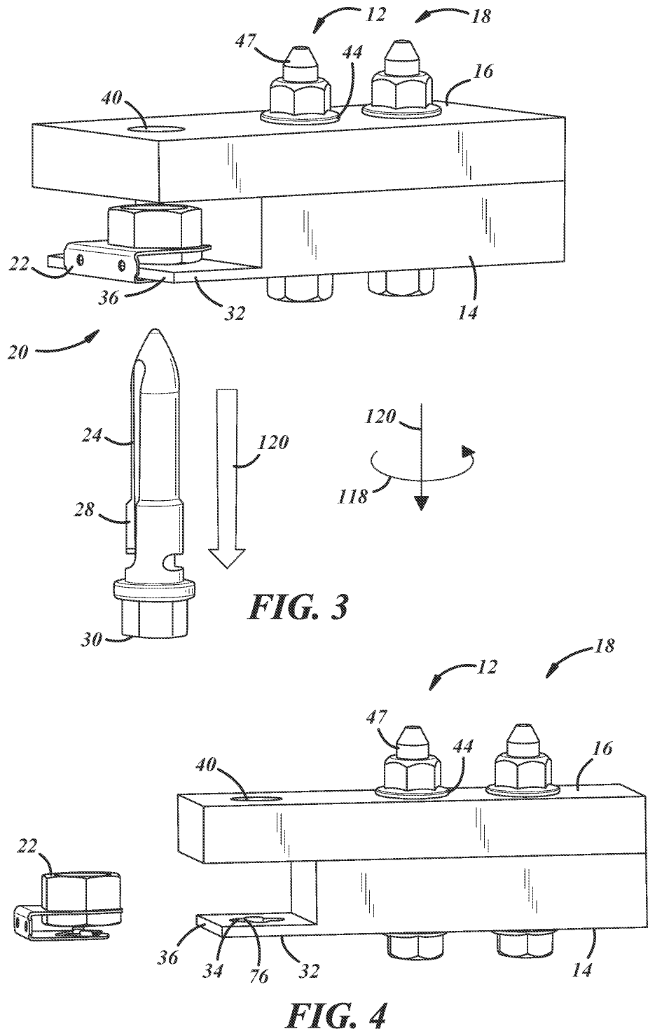

Once the primary element 14 and the secondary element 14 are secured to create the assembly 12 and ultimately the joined assembly 18, as shown more particularly in FIGS. 3-4, the threadless positioning pin 24 can be rotated in a second circumferential direction 118 opposite the first circumferential direction 116 so that the key 26 disengages from the circumferential portion 106 of the keyway 28 and rides along the transition portion 108 of the keyway. The threadless positioning pin 24 can then be retracted along a second longitudinal direction 120 opposite that of the first longitudinal direction out of the positioning hole 34 of the plate portion 32 and the threadless positioning retainer 22 of the primary element 14. FIG. 4 shows removal of the threadless positioning retainer 22 from the assembly 12; however, it is possible in some embodiments to leave the retainer with the joined assembly 18 of the primary and secondary elements 14, 16. Further, in some embodiments, the entire fastener 20 including the threadless positioning pin 24 may stay with the assembly 12. In other embodiments, removal of both the retainer 22 and the pin 24 may allow for the fastener 20 to be reusable in positioning other assemblies. In such an embodiment, it may be beneficial to have the pin 24 be made of a metallic material so that it can endure further usage. It is also possible to have, for example, one or more of the secondary positioning pins 42 be sacrificial. In such an embodiment, the positioning pin 42 may be made of a polymeric material, which can decrease manufacturing costs.

As used in this patent application, the terminology “for example,” “for instance,” “like,” “such as,” “comprising,” “having,” “including,” and the like, when used with a listing of one or more elements, is open-ended, meaning that the listing does not exclude additional elements. Likewise, when preceding an element, the articles “a,” “an,” “the,” and “said” mean that there are one or more of the elements. Moreover, directional words such as front, rear, top, bottom, upper, lower, radial, circumferential, axial, lateral, longitudinal, vertical, horizontal, transverse, and/or the like are employed by way of example and not limitation. As used herein, the term “may” is an expedient merely to indicate optionality, for instance, of an element, feature, or other thing, and cannot be reasonably construed as rendering indefinite any disclosure herein. Other terms are to be interpreted and construed in the broadest reasonable manner in accordance with their ordinary and customary meaning in the art, unless the terms are used in a context that requires a different interpretation.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A threadless positioning pin extending along a longitudinal axis, and comprising:
a head end including a head having a head end surface and a flange spaced away from the head end surface;
a pilot end including a point having a point end surface and a tapered surface extending away from the point end surface toward the head end;
a positioning shank extending away from the tapered surface toward the head end;
a retainer shank greater in diameter than the positioning shank and extending away from the positioning shank toward the head; and
a keyway in the positioning and retainer shanks and including
a longitudinal portion extending along part of the retainer shank,
a circumferential portion extending around a part of the retainer shank between the longitudinal portion and the flange of the head end, and
a transition portion extending between and connecting the longitudinal and circumferential portions.

2. The threadless positioning pin of claim 1, wherein the keyway begins on the tapered surface of the pilot end, extends along the positioning shank and the part of the retainer shank, and ends at a terminus of the circumferential portion.

3. The threadless positioning pin of claim 1, wherein the longitudinal portion is straight and extends parallel to the longitudinal axis.

4. The threadless positioning pin of claim 1, wherein the head is a hexagonal head having circumferentially extending wrench flats.

5. The threadless positioning pin of claim 1, wherein the flange is larger in diameter than the head and the retainer shank.

6. A threadless positioning retainer extending along a longitudinal axis, and comprising:
a first end having a first end surface;
a second end spaced longitudinally from the first end and having a second end surface;
an exterior; and
an interior including a threadless cylindrical inner surface and a key extending radially inwardly from the inner surface proximate the first end.

7. The threadless positioning retainer of claim 6, further comprising:
a chamfer extending between the first end surface and the threadless cylindrical inner surface, wherein the key has a key end surface coplanar with the first end surface.

8. The threadless positioning retainer of claim 6, wherein the key includes only one key.

9. The threadless positioning retainer of claim 6, wherein the exterior includes hexagonal wrench flats.

10. The threadless positioning retainer of claim 6, wherein the key is cube-shaped.

11. A threadless positioning fastener extending along a longitudinal axis, and comprising:
a threadless positioning pin including:
a head end including a head having a head end surface and a flange spaced away from the head end surface;
a pilot end including a point having a point end surface and a tapered surface extending away from the point end surface toward the head end;
a positioning shank extending away from the tapered surface toward the head end;
a retainer shank greater in diameter than the positioning shank and extending away from the positioning shank toward the head; and
a keyway in the positioning and retainer shanks and including
a longitudinal portion extending along the positioning shank and along part of the retainer shank,
a circumferential portion extending around part of the retainer shank between the longitudinal portion and the flange of the head end, and
a transition portion extending between and connecting the longitudinal and circumferential portions; and
a threadless positioning retainer including:
a first end having a first end surface;
a second end spaced longitudinally from the first end and having a second end surface;
an exterior; and
an interior including a threadless cylindrical inner surface and a key extending radially inwardly from the inner surface proximate the first end and configured to ride in the keyway of the threadless positioning pin.

12. The threadless positioning fastener of claim 11, wherein the keyway begins on the tapered surface of the pilot end, extends along the positioning shank and the part of the retainer shank, and ends at a terminus of the circumferential portion.

13. The threadless positioning fastener of claim 11, wherein the longitudinal portion is straight and extends parallel to the longitudinal axis.

14. A method of joining assembly elements, comprising:
providing a primary element including
a plate portion having a positioning hole, and
a threadless positioning retainer corresponding to the positioning hole and having a threadless cylindrical inner surface and a key extending radially inwardly from the inner surface;
advancing a threadless positioning pin along a first longitudinal direction into and through the positioning hole of the plate portion and the threadless positioning retainer of the primary element so that the key rides along a longitudinal portion of a keyway in the threadless positioning pin; and
rotating the threadless positioning pin in a first circumferential direction relative to the primary element so that key rides along a transition portion of the keyway and engages a circumferential portion of the keyway to trap the plate portion of the primary element between a head of the threadless positioning pin and a first end of the threadless positioning retainer.

15. The method of claim 14, further comprising:
moving a secondary element relatively toward the primary element;
aligning the threadless positioning pin with a primary locating hole of the secondary element;
continuing to move the secondary element relatively toward the primary element so that the threadless positioning pin enters the primary locating hole of the secondary element;
aligning a secondary positioning pin with a secondary locating hole of the secondary element;
further continuing to move the secondary element relatively toward the primary element so that the secondary positioning pin enters the secondary locating hole of the secondary element and until the secondary element is seated to the primary element;
securing the secondary element to the primary element to create an assembly of the primary and secondary elements;
rotating the threadless positioning pin in a second circumferential direction opposite that of the first circumferential direction relative to the primary element so that the key disengages from the circumferential portion of the keyway and rides along the transition portion of the keyway; and
retracting the threadless positioning pin along a second longitudinal direction opposite that of the first longitudinal direction and out of the positioning hole of the plate portion and the threadless positioning retainer of the primary element.

16. The method of claim 15, further comprising:
leaving the threadless positioning retainer with the assembly of the primary and secondary elements.

17. The method of claim 15, wherein the threadless positioning pin is metallic and reusable, and wherein the secondary positioning pin is polymeric and sacrificial.

18. The method of claim 15, wherein the primary element is a truck frame and the secondary element is a truck body.

19. The method of claim 14, wherein the rotating step includes rotation between 75 and 115 angular degrees, inclusive.

20. The method of claim 14, wherein the rotating step includes rotation between 250 and 290 angular degrees, inclusive.

21. The method of claim 14, wherein the positioning hole includes one or more lobes.

22. The method of claim 21, wherein the positioning hole includes a plurality of lobes that cooperate with tabs in the threadless positioning retainer.
